(19) United States
(12) Patent Application Publication
(10) Pub. No.: US 2026/0324643 A1
(43) Pub. Date: Oct. 22, 2026

(54) ADJUVANTS FOR MODULATION OF PLANT GROWTH REGULATORS

(71) Applicant: REMOTE EPIGENETICS INC., ENCINITAS, CA (US)

(72) Inventors: PAUL ZORNER, ENCINITAS, CA (US); JOVANNI NUNEZ, ENCINITAS, CA (US)

(21) Appl. No.: 19/644,560

(22) Filed: Apr. 10, 2026

Related U.S. Application Data
(60) Provisional application No. 63/787,332, filed on Apr. 11, 2025.

(51) Int. Cl. A01N 57/12; A01N 27/00; A01N 37/02; A01N 37/06; A01N 37/08; A01N 37/10; A01N 37/44; A01N 43/16; A01N 43/72; A01N 47/30; A01P 21/00

(52) U.S. Cl. CPC A01N 57/12; A01N 27/00; A01N 37/02; A01N 37/06; A01N 37/08; A01N 37/10; A01N 37/44; A01N 43/16; A01N 43/72; A01N 47/30; A01P 21/00

(57) ABSTRACT

The subject invention pertains to adjuvants for plant growth regulators for the use in modulating plant metabolic pathways.

### CROSS-REFERENCE TO A RELATED APPLICATION

This application claims priority to U.S. Provisional Patent Application No. 63/787,332, filed Apr. 11, 2025, which is incorporated herein by reference in its entirety.

### BACKGROUND OF THE INVENTION

Humans and other animals rely on plants and plant products as sources of nutrition, as well as a wide range of other products such as wood and fiber. Efforts have been made to increase the yield of crops and improve plants' responses to environmental challenges; however, there is a continual need for increasing the quantity, and improving the quality, of food and other crops.

Crops face a multitude of stresses that can significantly impair their growth, development, and productivity. These stresses can be categorized into abiotic and biotic factors, each posing unique challenges to agricultural systems. Abiotic stresses encompass environmental conditions such as drought, salinity, cold, and extreme temperatures, while biotic stresses arise from living organisms, including insects, pathogens, and competing plants. Understanding these stresses and the plant signaling pathways that respond to them is crucial for developing resilient crop varieties that can thrive in increasingly variable climates and challenging ecosystems.

Abiotic stresses, such as drought and salinity, can lead to reduced crop yields and diminished quality by affecting physiological and molecular responses within plants. For instance, drought stress triggers a cascade of physiological changes that enable plants to conserve water, while salinity stress results in osmotic pressure that hinders nutrient uptake. Cold stress also represents a significant barrier to plant productivity, particularly in temperate regions, necessitating acclimation strategies to survive chilling temperatures.

Drought stress is characterized by a lack of sufficient water, which can severely inhibit plant growth and development. The initial response to water deficit involves reduced water uptake by plant cells, which subsequently affects cell wall rheological properties due to the action of reactive oxygen species (ROS) on cell wall enzymes.

Moreover, dehydration induces an increase in endogenous abscisic acid (ABA) levels, activating downstream signaling pathways that regulate the expression of various stress-responsive genes, including transcription factors such as bZIP, which play a crucial role in enhancing plant tolerance to dehydration. The complexity of drought responses is further underscored by the interactions between sugars, reactive oxygen and nitrogen species, and various hormones, leading to a multifaceted acclimation process.

Salinity stress poses a significant threat to global agriculture by limiting crop yields, primarily through osmotic stress and ion toxicity. High salt concentrations in the soil create osmotic pressure that exceeds that of plant cells, hindering the uptake of water and essential minerals such as potassium (K+) and calcium (Ca2+). This stress results in secondary effects including impaired assimilate production, reduced cell expansion, and disruptions in membrane function, ultimately leading to decreased metabolic activity and growth inhibition. The role of ABA is pivotal in mediating plant responses to salinity, facilitating acclimatization and adaptation to high-salinity environments.

Cold stress is another critical abiotic factor that adversely affects plant productivity, especially in temperate regions where chilling and freezing conditions can occur. To cope with cold stress, plants undergo a process known as acclimation, which enables them to develop tolerance to lower temperatures. This response is mediated through various signaling pathways involving components such as ROS, protein kinases, and ABA, which collectively help plants to adapt to the detrimental effects of cold. Despite these adaptations, many important crops still struggle to achieve effective cold acclimation, resulting in significant challenges for agricultural productivity.

The interactions between different abiotic stresses can exacerbate their individual effects on plants. For instance, drought, salinity, and extreme temperatures can occur simultaneously, complicating the plant's stress response mechanisms. The dynamic nature of these stress responses, characterized by both elastic (reversible) and plastic (irreversible) adaptations, highlights the need for a comprehensive understanding of the underlying genetic and physiological processes. Moreover, effective phenotyping and field experiments are crucial for identifying and validating key genes associated with stress tolerance, thereby facilitating the development of resilient crop varieties in the face of increasing abiotic stressors due to climate change.

Biotic stresses include challenges posed by herbivorous insects, microbial pathogens, and competitive weeds, all of which can lead to significant yield losses. For example, herbivorous insects like aphids not only damage plant tissues but can also transmit diseases, compounding their detrimental effects.

Similarly, fungal, bacterial and viral pathogens can cause severe crop diseases, while competition from weeds can hinder the growth of cultivated plants by depleting essential resources.

The interplay between these biotic factors and plant defenses, such as physical barriers and chemical responses, underscores the complexity of managing biotic stress in agricultural practices. Overall, the management of abiotic and biotic stresses is essential for ensuring agricultural sustainability and food security in the face of climate change and environmental degradation. Research into plant signaling pathways and defense mechanisms continues to be a pivotal area of study, as it offers insights that could inform the development of stress-resistant crop varieties.

Biotic stress refers to the negative impacts on plants caused by living organisms, including insects, fungi, bacteria, viruses, and competing plants. These stresses can lead to reduced growth, diminished yields, and even plant mortality, making their management crucial for agricultural sustainability.

Microbial pathogens, including bacteria, fungi, and viruses, are prevalent sources of biotic stress. These pathogens can infect plants through direct penetration or by being transmitted by insect vectors. Bacterial diseases, such as those caused by Xanthomonas and Pseudomonas species, can lead to symptoms like leaf spots and wilts. Fungal pathogens, such as Fusarium and Phytophthora, are responsible for severe diseases including root rot, while viruses like the Tobacco mosaic virus can result in stunted growth and reduced yields. The interaction between pathogens and plant hosts is a major focus in research aimed at improving plant resilience.

Weeds pose a significant form of biotic stress by competing with crops for essential resources like light, water, and nutrients. This competition can reduce crop yield and is a major concern for farmers. Parasitic plants, such as Striga and Orobanche, further complicate this issue by attaching to the roots of host plants and extracting vital resources, often leading to severe yield losses in crops like corn and legumes, particularly in regions of Africa and Asia.

To combat biotic stress, plants have evolved complex defense mechanisms. These include both physical barriers, such as thorns and trichomes, and chemical defenses that involve the production of secondary metabolites. When faced with herbivory, plants can activate inducible defense responses through signaling pathways involving phytohormones like jasmonic acid and salicylic acid. The jasmonic acid pathway, for instance, is critical for activating defense genes in response to insect herbivores. Additionally, the recognition of herbivore-associated molecular patterns (HAMPs) in herbivore saliva can trigger signaling cascades that enhance plant defenses.

Thus, there is a need to identify plant genes and to develop improved, non-toxic, low-cost, and environmental-friendly materials and methods that effectively regulate stress responses in plants, in particular, agricultural crops, including edible crops.

Several plant signaling pathways have been evaluated for the development of small molecules that can enhance stress tolerance and/or alter responses to environmental signals in crops. These small molecules typically target key components of signaling pathways to modulate plant responses to abiotic and biotic stresses.

### BRIEF SUMMARY OF THE INVENTION

The subject invention provides plant growth regulator (PGR) compositions, and methods of using these compositions.

Advantageously, when used with an adjuvant of the subject invention, improved PGR activity can be achieved by the combined use of that PGR with the adjuvant of the subject invention.

In further embodiments of the subject invention, advantageous adjuvants described herein can be used to increase the effectiveness of a PGR so that less PGR is needed to achieve a desired PGR activity.

In specific embodiments, the adjuvants of the subject invention can be used to improve the efficacy of PGRs including, but not limited to, Gibberellin Pathway Modulators such as Gibberellic Acid (GA3); Abscisic Acid (ABA) Pathway Modulators, such as S-Abscisic Acid (S-ABA); Cytokinin Pathway Modulators, such as Forchlorfenuron; Systemic Acquired Resistance (SAR) Inducers, such as Acibenzolar-S-methyl; Auxin Pathway Modulators, such as like Gamma-aminobutyric acid (GABA) and glutamic acid; Ethylene pathway Modulators, such as Ethephon, 1-Methylcyclopropene (1-MCP), aminoethoxyvinylglycine (AVG) and aminooxyacetic acid (AOA); Jasmonic Acid Pathway Modulators, such as Methyl jasmonate; Salicylic Acid Pathway Modulators, such as Acibenzolar-S-methyl; Brassinosteroid Pathway Modulators, such as Brassinolide; and Strigolactone Pathway Modulators, such as Strigolactone analogs.

The PGR materials and methods of the subject invention can be used to, for example, improve stress tolerance; resistance to pathogens; resistance to pests; promote or delay ripening; promote or delay flowering; improve shoot structure and/or growth; improve water consumption efficiency; improve cold tolerance, heat tolerance, and/or flooding tolerance; or promote production of desirable metabolites such as sugar, medicinal compounds, flavours and fragrances, and/or dyes.

In certain embodiments, the methods of the subject invention are used for altering plant responses to environmental signals, for example, increases or decreases in day length, temperature, water availability, nutrient availability, wind, and/or chemicals.

The adjuvants on their own will show little or no effect, but when applied with a PGR, they exhibit an enhanced effect relative to plant growth regulator alone.

### DETAILED DESCRIPTION OF THE INVENTION

In specific embodiments, the subject invention provides materials and methods for enhancing the efficacy of a plant growth regulator (PGR) in comparison to the activity of the PGR when used alone, wherein an adjuvant of the subject invention is administered to a plant and/or the plant's surrounding environment either before, simultaneously with, or after the PGR.

Thus, the subject invention provides methods for delivering a PGR to plants and/or their surrounding environment to provide a benefit to the plant and/or environment, wherein the benefit is enhanced due to the use of the adjuvant composition.

In certain embodiments, the methods of the subject invention are used for improving plant resistance to environmental signals, wherein the environmental signals can include, for example, changes in sunlight exposure, temperature, water and nutrient availability, touch or chemical exposure.

According to the methods of the subject invention, the adjuvant and the PGR can be mixed together prior to administration to produce an agricultural composition as, for example, a sprayable tank mix. In some embodiments, the two components are applied individually but in such a way as to produce the agricultural composition at the point of administration. In such embodiments, the methods comprise applying the two components within, for example, 24 hours, preferably within 12 hours, more preferably within 60 minutes before or after one another.

In one embodiment, a further advantage of the compositions and methods of the subject invention is the facilitation of harvesting of nuts and/or fruit by promoting or delaying ripening, in, for example, citrus fruit, grapes, olives and other species and varieties of pomaceous fruit, stone fruit and nuts.

In one embodiment, the subject invention provides a method that comprises exposing a plant to a selected known PGR at recommended dose (or up to 90% lower than the recommended dose), and a compound from Table 1, Table 2 or Table 3, or any combination thereof (concentrations ranging, for example, from 0.1%10% v/v or w/v). Exposure to the compound can occur either in the vapor state or in a liquid soluble state sprayed on the shoots or applied directly to soil.

TABLE 1
Examples of adjuvant compounds

| Code Name | Compound Name |
|---|---|
| DRG1 | phenethyl butyrate |
| GDS19 | isoamyl salicylate |
| GDS22 | butyl salicylate |
| GDS6 | Benzyl Benzoate |
| DRG2 | iso-amyl butyrate |
| GDS1 | benzyl salicylate |
| NTR15 | Geranyl Formate |
| NTR7 | Citronellyl Formate |
| HINT5 | gamma-Cyclodextrin |

TABLE 2
Representative categories of adjuvant compounds

| General | | | | |
|---|---|---|---|---|
| Formula | | | | Non-limiting |
| No. | Category | Core Structure | R groups | Examples |
| 1 | Lactones | 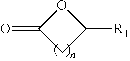 n = integer ≥ 1 | R¹ = e.g., H; halogens (F, Cl, Br, I); hydroxyl, alkyl, vinyl and/or aryl groups. In some embodiments, one or more saturated bonds may be | Gamma lactones Delta lactones Epsilon lactones |
| | | | substituted with unsaturated | |
| | | | bonds within the carbon ring. | |
| 2 | Lactones | 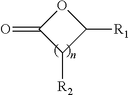 n = integer ≥ 1 | R¹ and R² = e.g., H; halogens (F, Cl, Br, I); hydroxyl, alkyl, vinyl and/or aryl groups. In some embodiments, one or more saturated bonds may be substituted with unsaturated bonds within the carbon ring. | Gamma lactones Delta lactones Epsilon lactones |
| 3 | Gamma lactones (5- membered | 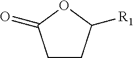 | R¹ = e.g., H; halogens (F, Cl, Br, I); various alkyl groups (CₙH₂ₙ₊₁, where n = integer ≥ 1). | Gamma- valerolactone Gamma- butyrolactone |
| | lactones) | | | Gamma-octalactone |
| | | | | Gamma-nonalactone |
| 4 | Delta lactones (6- membered lactones) | 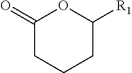 | R¹ = e.g., H, halogens (F, Cl, Br, I) and/or various alkyl groups (C₂H₂ₙ₊₁, where n = integer ≥ 1). | Delta-decalactone Delta-octalactone Delta-hexalactone Delta-undecalactone |
| 5 | Epsilon lactones (7- membered lactones) | 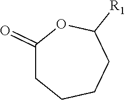 | R¹ = e.g., H, halogens (F, Cl, Br, I) and/or various alkyl groups (CₙH₂ₙ₊₁, where n = integer ≥ 1). | Caprolactone 7- methylcaprolactone |
| 6 | Formates | 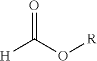 | R = halogens (F, Cl, Br, I), alkyl, cycloalkyl, allyl, benzyl and/or phenyl-based groups. | Alkyl formates, such as, e.g., methyl formate, ethyl formate, propyl |
| | | | | formate, isopropyl |
| | | | | formate, butyl |
| | | | | formate, sec-butyl |
| | | | | formate, iso-amyl |
| | | | | formate, hexyl |
| | | | | formate, octyl |
| | | | | formate and decyl |
| | | | | formate; |
| | | | | Unsaturated alkyl |
| | | | | formates, such as, |
| | | | | e.g., allyl formate, |
| | | | | vinyl formate, |
| | | | | (E/Z)-hezeny1 |
| | | | | formate and prenyl |
| | | | | formate; |
| | | | | Cycloalky1 |
| | | | | formates, such as, |
| | | | | e.g., cyclohexyl |
| | | | | formate, cyclooctyl |
| | | | | formate and |
| | | | | cyclodecyl formate; |
| | | | | and |
| | | | | Aromatic or benzy |
| | | | | formates, such as, |
| | | | | e.g., benzyl formate, |
| | | | | phenethyl formate and |
| | | | | cinnamyl |
| | | | | formate (E/Z). |
| 7 | Aromatic ester derivatives (benzoates, salicylates & cinnamates) | R—O—CO—Ar—R² 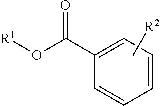 | R¹ = halogens (F, Cl, Br, I), benzyl, phenethyl, cinnamyl and/or alkyl. Ar = phenyl R² = halogens (F, Cl, Br, I), OH, OCH₃, alkyl and/or H. | Phenyl salicylate |
| 8 | Phenyl- propanoid esters | R¹—Ph—CH═CH—CH₂—O—CO—R² 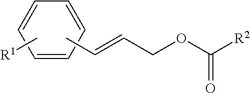 | R¹ = OCH₃, OH, halogens (F, Cl, Br, I), and/or alkyl. R² = acetate, butyrate, benzoate, and/or halogens (F, Cl, Br, I). | Isoeugenol acetate |
| 9 | Chalcone- like compounds | R¹—Ar¹—CH═CH—CO—Ar²—R² 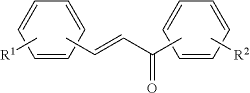 | R¹ and R² = OH, OCH₃, halogens (F, Cl, Br, I), and/or an aromatic. Ar¹ and Ar² = phenyl rings | Dehydrozingerone |
| 10 | Polyphenolic and/or flavonoid derivatives | 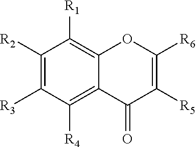 | R¹⁻⁶ = H, OH, OCH₃, halogens (F, Cl, Br, I), and/or prenyl groups. | Acacetin |
| 11 | Straight- chain fatty acids | CH₃—(CH₂)ₙ—COOH 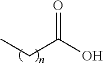 n = integer ≥ 1, e.g., 2 to 18 | | Palmitic acid |
| 12 | Polyhydro xyl-ated aromatics/ carbohydrates (glycosides) | 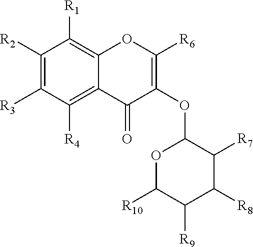 | R¹⁻¹⁰ = halogens (F, Cl, Br, I), glycoside sugars and/or OH. | Myrictrin |
| 13 | Cresyl salicylate derivatives | R¹—C₆H₄—O—CO—C₆H₄—OH 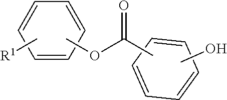 | R¹ = halogens (F, Cl, Br, I), para-cresyl (4—CH₃—Ph), ortho-cresyl (2-CH₃—Ph), phenethyl (—CH₃—CH₂—Ph), guaiacyl (2-methoxyphenyl), prenyl (3-methylbut-2-en-1- yl), 2-methylbutyl and/or 3- phenylpropyl. | Para-cresyl salicylate Ortho- cresyl salicylate Meta-cresyl salicylate Phenyl salicylate Phenethyl salicylate Guaiacyl salicylate |
| | | | | Prenyl salicylate |
| | | | | 2-methyl butyl |
| | | | | salicylate |
| | | | | 3-phenyl propyl |
| | | | | salicylate |
| 14 | Benzy1 and/or cinnamyl benzoates | R¹—CH₂—O—CO—C₆H₅ 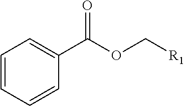 | R¹ = halogens (F, Cl, Br, I), benzyl (Ph—CH₂) and/or cinnamyl (3-phenylprop-2- enyl). | Benzyl benzoate Cinnamyl benzoate Benzyl phenyl carbinol Benzyl para-anisate Benzyl valerate Benzyl nicotinate |
| 15 | Benzyl derivatives | C₆H₅—CH₂—O—CO—R¹ 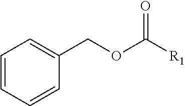 | R¹ = halogens (F, Cl, Br, I), nicotinic acid (3- pyridinecarboxylic acid), levulinic acid (4- oxopentanoic acid) and/or phenylcarbinol (Ph—CH—OH). | Benzyl nicotinate Benzyl anthranilate Benzyl levulinate Benzyl eugenol |
| 16 | Salicylate esters | R¹—CH₂—O—CO—C₆H—OH 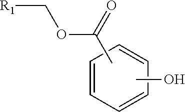 | R¹ = halogens (F, Cl, Br, I), benzyl (Ph—CH₂), guaiacyl (2-methoxyphenyl), isoamyl (3-methylbutyl), prenyl (3- methylbut-2-eny1), phenyl, cinnamyl (Ph—CH═CH—CH₂—), phenethyl (Ph—CH₂—CH₂—) and/or | Benzyl salicylate Guaiacyl salicylate Prenyl salicylate Phenyl salicylate Ortho-cresyl salicylate Phenethyl salicylate Cinnamyl salicylate |
| | | | alkyl/alkenyl groups | Isoamyl salicylate |
| | | | (e.g., butyl, hexyl, allyl). | Butyl salicylate |
| | | | | Hexyl salicylate |
| | | | | Allyl salicylate |
| | | | | 2-methyl butyl |
| | | | | salicylate |
| | | | | 3-phenyl propyl |
| | | | | salicylate |
| 17 | Anthranilate derivatives | R¹—O—CO—C₆H₄—NH₂ 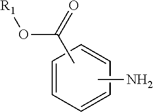 | R¹ = halogens (F, Cl, Br, I), benzyl (Ph—CH₂), phenethyl (Ph—CH₂—CH₂—), isoamyl (3- methylbutyl) and/ or amyl (pentyl). | Benzyl anthranilate Phenethyl anthranilate Isoamyl anthranilate Amyl anthranilate |
| 18 | Phenethyl and/or cinnamyl acetate derivatives | R¹—O—CO—CH₃ 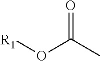 | R¹ = halogens (F, Cl, Br, I), cinnamyl (Ph—CH═CH—CH₂—), phenethyl (Ph—CH₂—CH₂—) and/or other related phenylalkyl | Cinnamyl acetate Phenethyl benzoate Phenethyl acetate Phenethyl propanoate |
| | | | substituents. | Phenethyl lactate |
| | | | | Phenethyl sorbate |
| | | | | Phenethyl resorcinol |
| 19 | Cinnamate esters | R¹—O—CO—CH═CH—C₆H₅ 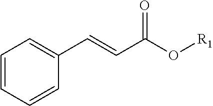 | R¹ = halogens (F, Cl, Br, I), ethyl, benzyl (Ph—CH₂), cinnamyl (Ph—CH═CH—CH₂—), butyl, hexyl, straight-chain alkyl groups. | Ethyl (E)-cinnamate Cinnamyl acetate Cinnamyl benzoate Cinnamyl cinnamate |
| 20 | Valerate derivatives | R¹—O—CO—(CH₂)₃—CH₃ 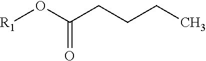 | R¹ = halogens (F, Cl, Br, I), benzyl (Ph—CH₂) and/or cinnamyl (Ph—CH═CH— CH₃). | Benzyl valerate |

TABLE 3
Representative adjuvant compounds

| Code | Compound name |
|---|---|
| HGRA-1 | piperine |
| HGRA-4 | Dehydrozingerone |
| HGRA-5 | Myricitrin |
| HGRA-6 | NONIVAMIDE |
| HGRA-7 | Valeric acid |
| HGRA-8 | 2-Phenylethyl hexanoate |
| HGRA-9 | Phenyl salicylate |
| HGRA-10 | Isoeugenol |
| HGRA-12 | Isoquercitrin |
| HGRA-13 | Phenethyl decanoate |
| HGRA-14 | Phenethyl octanoate |
| HGRA-15 | 3-Phenylpropionic acid |
| HGRA-16 | N-benzoylanthranilic acid |
| HGRA-17 | Caproic Acid |
| HGRA-18 | Phenethyl butyrate |
| HGRA-19 | Benzyl butyrate |
| HGRA-20 | Methyl 2-furoate |
| HGRA-21 | 2-Methylbenzyl acetate |
| HGRA-22 | 2-Methyl-3-phenylpropanal |
| HGRA-23 | 2-Methyl-3-phenylpropionic acid |
| HGRA-24 | Vanillin |
| HGRA-25 | 2-Methoxy-4-methylphenol |
| HGRA-26 | 2-Methoxy-4-propylphenol |
| HGRA-27 | 2-Methoxybenzaldehyde |
| HGRA-28 | 2-Methoxybenzyl acetate |
| HGRA-29 | Cinnamyl butyrate |
| HGRA-30 | Cinnamyl acetate |
| HGRA-31 | Phenethyl acetate |
| HINT-1 | alpha-Cyclodextrin |
| HINT-2 | Benzaldehyde, 4-hydroxy-3-methoxy- |
| HINT-3 | Tetradecanoic acid, potassium salt |
| HINT-5 | gamma-Cyclodextrin |
| HINT-7 | Wintergreen oil |
| HINT-8 | Lanolin |
| HINT-9 | Dextrins |
| HINT-10 | Locust bean gum |
| HINT-13 | Magnesium benzoate |
| HINT-17 | 9-Octadecenoic acid, 12-hydroxy-, monopotassium salt, |
| | (9Z, 12R)- |
| HACT-2 | oleic acid |
| HACT-3 | palmitoleic acid |
| HACT-4 | myristic acid |
| HACT-5 | palmitic acid |
| HACT-6 | stearic acid |
| HACT-7 | linoleic acid |
| HACT-8 | eugenyl acetate |
| HACT-10 | lauryl sulfate |
| HACT-11 | geranyl acetate |
| HACT-12 | malic acid |
| HACT-13 | Geraniol |
| HACT-14 | 3-Methylthiophene |
| NGDS-1 | Resveratrol |
| NGDS-2 | benzyl salicylate |
| NGDS-3 | guaiacyl salicylate |
| NGDS-4 | Chalconaringenin |
| NGDS-5 | para-cresyl salicylate |
| NGDS-6 | benzoyl anthranilic acid |
| NGDS-7 | para-anisyl salicylate |
| NGDS-8 | para-cresyl 3-methyl crotonate |
| NGDS-9 | prenyl salicylate |
| NGDS-10 | phenyl salicylate |
| NGDS-11 | 1-(2-hydroxyphenyl)-3-(pyridin-4-yl)propan-1- |
| | one |
| NGDS-12 | ortho-cresyl salicylate |
| NGDS-13 | para-anisyl benzoate |
| NGDS-14 | benzyl anthranilate |
| NGDS-15 | phenethyl salicylate |
| NGDS-16 | acetaminosalol |
| NGDS-17 | 2-Phenylethyl 2-furancarboxylate |
| NGDS-18 | beta-naphthyl benzoate |
| NGDS-19 | 2-(2-phenyl ethyl) chromone |
| NGDS-20 | beta-naphthyl anthranilate |
| NGDS-21 | 4-dihydromethyl-2H-pyran-2-yl guaiacol |
| NGDS-22 | cinnamyl salicylate |
| NGDS-23 | benzyl nicotinate |
| NGDS-24 | Flavones |
| NGDS-25 | phenethyl resorcinol |
| NGDS-26 | Acacetin |
| NGDS-27 | eriodictyol |
| NGDS-28 | Phloretin |
| NGDS-29 | 2-Phenylethyl 2-aminobenzoate |
| NGDS-30 | aromadedrin |
| NGDS-31 | Benzoyl peroxide |
| NGDS-32 | heliotropyl phenyl acetate |
| NGDS-33 | Chalcone |
| NGDS-34 | benzyl para-anisate |
| NGDS-35 | cinnamyl anthranilate |
| NGDS-36 | (Z)-2-penten-1-yl benzoate |
| NGDS-37 | 2-naphthyl phenyl ketone |
| NGDS-38 | bergamottin |
| NGDS-39 | Isoimperatorin |
| NGDS-40 | para-cresyl benzoate |
| NGDS-41 | guaiacyl benzoate |
| NGDS-42 | Caffeic acid ethyl ester |
| NGDS-43 | 4-phenyl propyl pyridine |
| NGDS-44 | 2-Phenylethyl benzoate |
| NGDS-45 | Benzyl Benzoate |
| NGDS-46 | 2-methyl butyl salicylate |
| NGDS-47 | phenethyl sorbate |
| NGDS-48 | para-anisaldehyde/methyl anthranilate schiff's base |
| NGDS-49 | Dibenzyl ether |
| NGDS-50 | ortho-anisyl benzoate |
| NGDS-51 | Cinnamyl benzoate |
| NGDS-52 | 1-(2-hydroxy-4-methoxyphenyl)-3-(pyridin-2-yl)propan-1- |
| | one |
| NGDS-53 | Ethyl 4-methylphenoxyacetate |
| NGDS-54 | Benzyl trans-2-methyl-2-butenoate |
| NGDS-55 | \alpha, alpha-dimethyl anisyl acetone\ |
| NGDS-56 | styryl acetate |
| NGDS-57 | amyl cinnamate |
| NGDS-58 | ortho-cresyl benzoate |
| NGDS-59 | methyl phenyl methylene aminobenzoate |
| NGDS-60 | phenethyl pyridine |
| NGDS-61 | (Z)-N-Coumaroyl-5-hydroxyanthranilic acid |
| NGDS-62 | homoeriodictyol |
| NGDS-63 | Benzyl 2,3-dimethyl-2-butenoate |
| NGDS-64 | meta-cresyl benzoate |
| NGDS-65 | (Z)-anisylidene acetone |
| NGDS-66 | guaiacyl phenyl acetate |
| NGDS-67 | 3-phenyl propyl salicylate |
| NGDS-68 | geranyl cantabiline |
| NGDS-69 | cortex pyridine |
| NGDS-70 | ethyl para-cresyl carbonate |
| NGDS-71 | ethyl phenoxyacetate |
| NGDS-72 | Hesperetin |
| NGDS-73 | \3′,7-dihydroxy-4′-methoxyflavan\ |
| NGDS-74 | allyl (Z)-cinnamate |
| NGDS-75 | Bisdemethoxycurcumin |
| NGDS-76 | Amyl salicylate |
| NGDS-77 | phenyl acetaldehyde/methyl anthranilate schiff's base |
| NGDS-78 | p-Tolyl phenylacetate |
| NGDS-79 | 4-formyl phenyl butyrate |
| NGDS-80 | 4-Methoxybenzyl phenylacetate |
| NGDS-81 | para-cresyl 3-oxo-3-phenyl propionate |
| NGDS-82 | (E)-2-hexen-1-yl salicylate |
| NGDS-83 | furfuryl phenyl acetate |
| NGDS-84 | butyl 2-naphthyl ether |
| NGDS-85 | (E)-cinnamyl acetate |
| NGDS-86 | Cinnamyl acetate |
| NGDS-87 | ethyl (E)-cinnamate |
| NGDS-88 | Ethyl cinnamate |
| NGDS-89 | 2-para-cresyl oxyethyl acetate |
| NGDS-90 | neryl anthranilate |
| NGDS-91 | cinnamaldehyde/methyl anthranilate schiff's base |
| NGDS-92 | cinnamyl tiglate |
| NGDS-93 | (E)-cinnamyl propionate |
| NGDS-94 | 1-(4-Methoxyphenyl)-1-penten-3-one |
| NGDS-95 | Imperatorin |
| NGDS-96 | para-cresyl valerate |
| NGDS-97 | meta-cresyl phenyl acetate |
| NGDS-98 | 3-methyl-3-buten-1-yl benzoate |
| NGDS-99 | para-anisyl acetoacetate |
| NGDS-100 | isoamyl p-methoxycinnamate |
| NGDS-101 | isoeugenyl benzoate |
| NGDS-102 | (Z)-3-hexen-1-yl cinnamate |
| NGDS-103 | Eugenyl benzoate |
| NGDS-104 | isoamyl salicylate |
| NGDS-105 | Phenylmethyl benzeneacetate |
| NGDS-106 | Curcumin |
| NGDS-107 | butyl cinnamate |
| NGDS-108 | cinnamyl acetoacetate |
| NGDS-109 | para-cresyl phenyl ether |
| NGDS-110 | citral/methyl anthranilate schiff's base |
| NGDS-111 | cinnamyl valerate |
| NGDS-112 | Allyl phenoxyacetate |
| NGDS-113 | 2-Phenylethyl 3-phenyl-2-propenoate |
| NGDS-114 | geranyl benzoate |
| NGDS-115 | (E)-3-butylidene phthalide |
| NGDS-116 | geranyl cinnamate |
| NGDS-117 | neryl cinnamate |
| NGDS-118 | cinnamyl cinnamate |
| NGDS-119 | amyl anthranilate |
| NGDS-120 | benzyl (E)-isoeugenol |
| NGDS-121 | Isoeugenol benzyl ether |
| NGDS-122 | cinnamyl phenyl acetate |
| NGDS-123 | Phenethyl phenylacetate |
| NGDS-124 | (R)-benzoin |
| NGDS-125 | (S)-benzoin |
| NGDS-126 | Benzoin |
| NGDS-127 | benzyl eugenol |
| NGDS-128 | 4-Methylphenyl 3-methylbutanoate |
| NGDS-129 | (Z)-3-hexen-1-yl salicylate |
| NGDS-130 | Dibenzyl |
| NGDS-131 | 3-phenyl propyl benzoate |
| NGDS-132 | Oxypeucedanin hydrate |
| NGDS-133 | Psoralen |
| NGDS-134 | methyl (para-tolyl oxy) acetate |
| NGDS-135 | butyl salicylate |
| NGDS-136 | Butylparaben |
| NGDS-137 | sophoraflavanone B |
| NGDS-138 | isoamyl anthranilate |
| NGDS-139 | xanthohumol |
| NGDS-140 | 2-hydroxyethyl phenoxyacetate |
| NGDS-141 | propyl cinnamate |
| NGDS-142 | Pentyl benzoate |
| NGDS-143 | (R)-delta-undecalactone |
| NGDS-144 | (E)-cinnamyl butyrate |
| NGDS-145 | diphenethyl ether |
| NGDS-146 | \2,5-distyryl pyrazine\ |
| NGDS-147 | Bergaptol |
| NGDS-148 | Bergaptol |
| NGDS-149 | butyl para-anisate |
| NGDS-150 | benzyl (E)-crotonate |
| NGDS-151 | turmeric root oil vietnam |
| NGDS-152 | citrus red 2 |
| NGDS-153 | Piperine |
| NGDS-154 | isoeugenyl phenyl acetate |
| NGDS-155 | ivy carbaldehyde/methyl anthranilate schiff's base |
| NGDS-156 | isoamyl (E)-cinnamate |
| NGDS-157 | meta-cresyl phenyl ether |
| NGDS-158 | cinnamaldehyde butylene glycol acetal |
| NGDS-159 | (Z)-3-hexen-1-yl anthranilate |
| NGDS-160 | phenethyl oxyacetaldehyde |
| NGDS-161 | Shikonin |
| NGDS-162 | phenethyl lactate |
| NGDS-163 | eugenyl phenyl acetate |
| NGDS-164 | 2-methyl butyl benzoate |
| NGDS-165 | (Z)-3-hexen-1-yl anisate |
| NGDS-166 | 3-(2-Furany1)-2-phenyl-2-propenal |
| NGDS-167 | para-cresyl hexanoate |
| NGDS-168 | cinnamyl hexanoate |
| NGDS-169 | 1,3-Diphenyl-2-propanone |
| NGDS-170 | butyl anthranilate |
| NGDS-171 | hexyl cinnamate |
| NGDS-172 | heraclenol |
| NGDS-173 | cinnamyl eugenol |
| NGDS-174 | phenethyl tiglate |
| NGDS-175 | eugenyl 2-methyl-2-butenoate |
| NGDS-176 | 1-(2-phenyl ethoxy)-2-(4-methyl phenoxy)ethanol |
| NGDS-177 | annatto seed extract (solvent-extracted bixin) |
| NGDS-178 | linalyl anthranilate |
| NGDS-179 | 3-phenyl propyl cinnamate |
| NGDS-180 | 2,5-Dimethyl-1,4-dithiane-2,5-diol |
| NGDS-181 | annatto seed extract (solvent-extracted norbixin) |
| NGDS-182 | annatto seed powder |
| NGDS-183 | benzyl phenyl carbinol |
| NGDS-184 | (E)-3-hexen-1-yl benzoate |
| NGDS-185 | cis-3-Hexenyl benzoate |
| NGDS-186 | 2-Propenyl 2-aminobenzoate |
| NGDS-187 | allyl salicylate |
| NGDS-188 | para-anisyl isobutyrate |
| NGDS-189 | 2-Phenylethyl pentanoate |
| NGDS-190 | 3-methyl dibenzothiophene |
| NGDS-191 | O-geranyl vanillin |
| NGDS-192 | Benzyl 2-methylbutanoate |
| NGDS-193 | Amyl phenylacetate |
| NGDS-194 | phellopterin |
| NGDS-195 | \1,3-dimethyl-3-butenyl salicylate\ |
| NGDS-196 | geranyl phenyl acetate |
| NGDS-197 | Geranyl phenylacetate |
| NGDS-198 | cinnamyl 2-methyl butyrate |
| NGDS-199 | cyclohexyl cinnamate |
| NGDS-200 | Linalyl cinnamate |
| NGDS-201 | (E)-2-hexen-1-yl phenyl acetate |
| NGDS-202 | cis-3-Hexenyl phenylacetate |
| NGDS-203 | benzyl valerate |
| NGDS-204 | 3-phenyl propyl crotonate |
| NGDS-205 | 2-isopropoxyethyl salicylate |
| NGDS-206 | 2-Phenylethyl 3-methyl-2-butenoate |
| NGDS-207 | gamma-Mangostin |
| NGDS-208 | 2-phenoxyethyl formate |
| NGDS-209 | phenyl propyl phenyl acetate |
| NGDS-210 | 2-Phenylethyl acetate |
| NGDS-211 | 2-Phenylethyl propanoate |
| NGDS-212 | benzyl levulinate |
| NGDS-213 | hexyl salicylate |
| NGDS-214 | Magnolol |
| NGDS-215 | para-cresyl butyrate |
| NGDS-216 | isobutyl para-anisate |
| NGDS-217 | Irisone B |
| NGDS-218 | S-methyl thiopropionate |
| NGDS-219 | Herniarin |
| NGDS-220 | 2-(Phenylethenyl)-1,3-dioxolane |
| NGDS-221 | lactoyl tyramine |
| NGDS-222 | cuminyl phenyl acetate |
| NGDS-223 | Trilobatin |
| NGDS-224 | Ethyl 3-oxo-3-phenylpropanoate |

In certain embodiments, the compositions and methods of the subject invention can be applied to plants to alter a plant's response to an environmental signal.

As used herein, an “environmental signal” refers to an environmental variable that influences plant growth, development and adaptation, often eliciting alteration in, for example, gene expression, protein activity and metabolic processes in plants. Environmental signals can include, but are not limited to increases or decreases in, for example, day length, light exposure, temperature, water availability, nutrient availability, carbon dioxide, pollination, reactive oxygen species, gravity, wind, touch (mechanical influences) or chemical influences.

The improvement of the plant growth regulator's effect by adjuvants can be tested by, for example, quantifying the parameters affected in the plant by the specific PGR, such as improve stress tolerance; resistance to pathogens; resistance to pests; promote or delay ripening; promote or delay flowering; improve shoot structure and/or growth; improve water consumption efficiency; improve cold tolerance, heat tolerance, and/or flooding tolerance; or promote production of desirable metabolites such as sugar, medicinal compounds, flavours and fragrances, and/or dyes.

The adjuvants on their own will show little or no effect, but when applied with a PGR, they will show an enhanced effect relative to the PGR alone.

In certain embodiments, the methods can further comprise testing the treated plant's level of resistance to the environmental signal as a result of the treatment by, for example, quantifying and comparing a response of the specific environmental signal in the plant before, and at a time point after, treatment. Such responses can include, for example, phototropism, thigmotropism, hydrotropism, thigmomorphogenesis, altered circadian rhythms (e.g., temperature and day length-mediated flowering, bolting and fruiting), root growth, gene and protein expression, hormone production, dormancy, and leaf abscission.

Thus, improvements of activity can be confirmed by, for example, quantifying increases in activity upon addition of adjuvant, particularly when no or minimal significant effect is found for either compound alone.

The methods and compositions according to the subject invention can be applied in conventional manner by using techniques with which a skilled person is familiar. Suitable techniques include spraying, atomizing, dusting, spreading or watering.

In preferred embodiments, the compositions according to the subject invention are applied to plants by spraying the leaves. The application can be carried out using, for example, water as carrier by customary spraying techniques using spray liquor amounts of from about 10 to 1000 l/ha (for example from 300 to 400 l/ha).

### Definitions

As used herein “contemporaneous” means simultaneously or sufficiently close in time to achieve the desired effect described herein. Contemporaneous includes, for example, less than a month, a week, a day, or an hour.

As used herein, the singular forms “a”, “an”, and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising”. The transitional terms/phrases (and any grammatical variations thereof) “comprising”, “comprises”, and “comprise” can be used interchangeably; “consisting essentially of”, and “consists essentially of” can be used interchangeably; and “consisting”, and “consists” can be used interchangeably.

When ranges are used herein, such as for dose ranges, combinations and subcombinations of ranges (e.g., subranges within the disclosed range), specific embodiments therein are intended to be explicitly included.

The transitional term “comprising,” “comprises,” or “comprise” is inclusive or open-ended and does not exclude additional, unrecited elements or method steps. By contrast, the transitional phrase “consisting of” excludes any element, step, or ingredient not specified in the claim. The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 0-20%, 0 to 10%, 0 to 5%, or up to 1% of a given value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed. In the context of compositions containing amounts of concentrations of ingredients where the term “about” is used, these values include a variation (error range) of 0-10% around the value (X±10%).

In the present disclosure, ranges are stated in shorthand to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc. Values having at least two significant digits within a range are envisioned, for example, a range of 5-10 indicates all the values between 5.0 and 10.0 as well as between 5.00 and 10.00 including the terminal values. When ranges are used herein, combinations and subcombinations of ranges (e.g., subranges within the disclosed range) and specific embodiments therein are explicitly included.

As used herein, “applying” a composition or product to a site refers to contacting a composition or product with a site such that the composition or product can have an effect on that site.

As used herein, the term “plant” includes, but is not limited to, any species of woody, ornamental or decorative, crop or cereal, aquatic plant (crop or weed growing in bodies of water), turf grass, range grasses, any weed species, cover crops, fruit plant or vegetable plant, flower or tree, macroalga or microalga, phytoplankton and photosynthetic algae (e.g., green algae Chlamydomonas reinhardtii). “Plant” also includes a unicellular plant (e.g., microalga) and a plurality of plant cells that are largely differentiated into a colony (e.g., volvox) or a structure that is present at any stage of a plant's development. Such structures include, but are not limited to, a fruit, a seed, a shoot, a stem, a leaf, a root, a flower petal, etc. Plants can be standing alone, for example, in a garden, or can be one of many plants, for example, as part of an orchard, crop (or crop weed complexes), pasture, multi-species cover crops or fallow land populated by numerous weed species.

The term “effective amount” denotes an amount of the active ingredient that is sufficient to yield a desired effect, and which does not result in a substantial damage to desired plants. Such an amount can vary and is dependent on various factors, such as the plants to be controlled, the treated crop or material, the climatic conditions and the specific composition according to the invention used.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. It will be further understood that terms, such as those defined in commonly used dictionaries, should be interpreted as having a meaning that is consistent with their meaning in the context of the relevant art and/or as otherwise defined herein.

Methods of Modulating Plant Growth and/or Responses to Stress

The subject invention can be practiced with standard methods and equipment that are used for, for example, maintenance of farmland, other agriculture areas, industrial sites, pastures, bodies of water, homeowner landscapes and gardens. For example, the PGR composition can be applied in liquid form using a standard spray boom or an irrigation system. The composition can also be applied as a granule, as a coating (e.g., seed coating), or impregnated into prills. Additionally, the composition can be applied using a manual spreader, such as a broadcast spreader, a drop spreader, a handheld spreader, or a handheld sprayer. The composition can also be applied using aerial spreading (e.g., crop dusting), by, for example, airplane, helicopter, or drone.

In certain embodiments, the user applies the agrochemical composition according to the invention from a pre-dosage device, a knapsack sprayer, a spray tank, a spray plane, or an irrigation system. Typically, in this embodiment, the agrochemical composition is made up with water, buffer, and/or further auxiliaries to the desired application concentration and the ready-to-use spray liquor or the agrochemical composition according to the invention is thus obtained. In specific embodiments, 10 to 2000 liters, preferably 50 to 400 liters, of the ready-to-use spray liquor are applied per hectare of agricultural useful area.

According to one embodiment, either individual components of the agrochemical composition according to the invention or partially premixed components, e.g., agrochemical components comprising a PGR and an adjuvant may be mixed by the user in a spray tank and further auxiliaries and additives may be added, if appropriate.

In a further embodiment, individual components of the agrochemical composition according to the invention, may be mixed by the user in a spray tank and further auxiliaries may be added, if appropriate.

In other embodiments, the adjuvant can be incorporated into the PGR formulation (e.g., a pre-mix) as a component of a single commercial formulation.

The compounds can be delivered with water or as a neat liquid, solid or solution. The compounds may be sprayed into or onto soil at the time of planting, sprayed into or onto soil at intervals post emergence, or sprayed on the foliage of a plant. In addition, the compounds may be applied to seeds prior to planting using established methods. For example, they may be coated on seeds with an inert vehicle, tumbled, and dried.

The compounds can be applied to soil, or plants at any acceptable rate. For example, the compounds can be applied at a rate of at least about 0.1 kg per acre, at least 0.5 kg per acre, at least 1 kg per acre, at least about 2 kg per acre, at least about 5 kg per acre, at least about 10 kg per acre, or at least about 20 kg per acre, although lower or higher application rates are not excluded.

In certain embodiments, the subject compositions can be stored at about 1° C. to about 37° C. or about 5° C. to about 25° C. In preferred embodiments, the plants or fungi are treated and grown at a temperature between about 5° C. to about 25° C. In other embodiments, the plants or fungi can be grown and treated at a temperature of about −10° C. to about 45° C.

The mode of application depends upon the formulation of the composition, and can include, for example, spraying, pouring, sprinkling, injecting, spreading, mixing, dunking, fogging, dripping, and misting. Formulations can include, for example, liquids, dry and/or wettable powders, soluble powders, flowable powders, dry flowables, emulsifiable concentrates, ultra-low-volume concentrates, dusts, granules (e.g., water dispersible granules), pellets, emulsions, microcapsules, nanocapsules, gels, pastes and/or aerosols. In an exemplary embodiment, the composition is applied after the composition has been prepared by, for example, mixing the composition with water.

All plants and plant parts can be treated in accordance with the subject invention. Plant parts or tissues are understood as meaning all aerial and subterranean parts and organs of the plants, such as a shoot, leaf, flower and root, examples which may be mentioned being leaves, needles, stalks, stems, flowers, buds, fruit bodies, fruits and seeds, but also roots, tubers and rhizomes. The plant parts also include crop material and vegetative and generative propagation material, for example cuttings, tubers, rhizomes, slips and seeds.

In one embodiment, the site to which the composition is applied is the soil in which plants will be planted or are growing (e.g., a field, an orchard, a grove, a pasture/prairie or a forest). The compositions of the subject invention can be pre-mixed with irrigation fluids, such that the compositions percolate through the soil and can be delivered to, for example, the soil.

Alternatively, the compositions can be applied aerially. In one embodiment, the compositions are applied to soil surfaces, with or without water, where the beneficial effect of the soil application can be activated by rainfall, sprinkler, flood, or drip irrigation. The subject composition can be contacted to any plant tissue, such as, for example, the primary root, secondary root, stems, leaves, fruits, flowers, or seeds.

The methods and compositions of the subject invention can be used either alone or in combination with additional components, such as herbicides, fertilizers, pesticides and/or other soil amendments. Preferably, the additional components are non-toxic and environmentally-friendly. The exact materials and the quantities thereof can be determined by, for example, a grower or soil scientist having the benefit of the subject disclosure.

### Target Plants

The target plants can be plants to be protected from stresses, or they can be crop plants that derive an agriculture benefit from treatment with a composition of the subject invention. This agriculture benefit can be, for example, improved growth, altered metabolic profile, improved or increased desired compounds, or improved harvesting.

Examples of plants for which the subject invention is useful include, but are not limited to, cereals and grasses (e.g., wheat, barley, rye, oat, rice, maize, sorghum, corn, millet, triticale, turf, pasture grass), beets (e.g., sugar or fodder beets); fruit (e.g., grapes, strawberries, raspberries, blackberries, pomaceous fruit, stone fruit, soft fruit, apples, pears, plums, peaches, almonds, cherries or berries); leguminous crops (e.g., beans, lentils, peas or soya); oil crops (e.g., oilseed rape, mustard, poppies, olives, sunflowers, coconut, castor, cocoa, cacao or ground nuts); cucurbits (e.g., pumpkins, cucumbers, squash or melons); fiber plants (e.g., cotton, flax, hemp or jute); citrus fruit (e.g., oranges, lemons, grapefruit or tangerines); vegetables (e.g., spinach, lettuce, asparagus, cabbages, broccolis, carrots, onions, tomatoes, potatoes or bell peppers); Lauraceae (e.g., avocado, Cinnamonium or camphor); and also tobacco, nuts, herbs, spices, medicinal plants, coffee, eggplants, sugarcane, tea, pepper, grapevines, hops, the plantain family, latex plants, cut flowers and ornamentals.

Further types of plants that can benefit from application of the products and methods of the subject invention include, but are not limited to: row crops (e.g., corn, soy, sorghum, peanuts, potatoes, etc.), field crops (e.g., alfalfa, wheat, grains, etc.), tree crops (e.g., walnuts, almonds, pecans, hazelnuts, pistachios, etc.), citrus crops (e.g., orange, lemon, grapefruit, etc.), fruit crops (e.g., apples, pears, strawberries, blueberries, blackberries, etc.), turf crops (e.g., sod), ornamentals crops (e.g., flowers, vines, etc.), vegetables (e.g., tomatoes, carrots, etc.), vine crops (e.g., grapes, etc.), forestry (e.g., pine, spruce, eucalyptus, poplar, etc.), managed pastures (any mix of plants used to support grazing animals).

Further plants that can benefit from the products and methods of the invention include all plants that belong to the superfamily Viridiplantae, in particular monocotyledonous and dicotyledonous plants including fodder or forage legumes, ornamental plants, food crops, trees or shrubs selected from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp, Artocarpus spp., Asparagus officinalis, Avena spp. (e.g., A. sativa, A. fatua, A. byzantina, A. fatua var. sativa, A. hybrida), Averrhoa carambola, Bambusa sp., Benincasa hispida, Bertholletia excelsea, Beta vulgaris, Brassica spp. (e.g., B. napus, B. rapa ssp. [canola, oilseed rape, turnip rape]), Cadaba farinosa, Camellia sinensis, Cannabis indica, Cannabis sativa, Cannabis ruderalis, Capsicum spp., Carex elata, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis (e.g., E. guineensis, E. oleifera), Eleusine coracana, Eragrostis tef, Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp. (e.g., G. max, Soja hispida or Soja max), Gossypium hirsutum, Helianthus spp. (e.g., H. annuus), Hemerocallis fulva, Hibiscus spp., Hordeum spp. (e.g., H. vulgare), Ipomoea batatas, Juglans spp., Lactuca sativa, Lathyrus spp., Lens culinaris, Linum usitatissimum, Litchi chinensis, Lotus spp., Luffa acutangula, Lupinus spp., Luzula sylvatica, Lycopersicon spp. (e.g., L. esculentum, L. lycopersicum, L. pyriforme), Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp. (e.g., O. sativa, O. latifolia), Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g., S. tuberosum, S. integrifolium or S. lycopersicum), Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp. (e.g., T. aestivum, T. durum, T. turgidum, T. hybernum, T. macha, T. sativum, T. monococcum or T. vulgare), Tropaeolum minus, Tropaeolum majus, Vaccinium spp., Vicia spp., Vigna spp., Viola odorata, Vitis spp., Zea mays, Zizania palustris, Ziziphus spp., amongst others.

Further examples of plants of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Turfgrasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); blue gramma (Bouteloua gracilis); buffalo grass (Buchloe dactyloids); sideoats gramma (Boutelona curtipendula).

Plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc.

Further plants of interest include Cannabis (e.g., sativa, indica, and ruderalis) and industrial hemp.

### Plant Growth Regulators

PGRs that can be used according to the subject invention, include, but are not limited to, the following examples.
1. Gibberellin Pathway Modulators:
   ProGibb® 40% Plant Growth Regulator:
      Active Ingredient: Gibberellic acid (GA3)
      Approved Crops: Artichoke, avocado, banana, bell peppers, blueberry, carrot, celery, cherries, citrus, coffee, collard greens, cotton, cranberry, cucumber, grapes, dry bean, hops, Italian prune, leaf lettuce, lettuce for seed, melon, mustard greens, peanut, pecan, pepper, pineapple, potato seed, rhubarb, rice, soybean, spinach, stone fruit, strawberry, turnip greens, watercress, pastures, forage crops, corn, and soybean.
2. Abscisic Acid (ABA) Pathway Modulators:
   ProTone® SG Plant Growth Regulator:
      Active Ingredient: S-Abscisic Acid (S-ABA)
      Approved Crops: Grapes (for color development) and various other fruits to manage maturation.
3. Cytokinin Pathway Modulators:
   Forchlorfenuron (CPPU):
      Active Ingredient: Forchlorfenuron
      Approved Crops: Kiwifruit and grapes.
4. Systemic Acquired Resistance (SAR) Inducers:
   Actigard® 50WG:
      Active Ingredient: Acibenzolar-S-methyl
      Approved Crops: Various vegetables, including tomatoes, peppers, and leafy greens, to enhance resistance against certain diseases.
5. Auxin Pathway Modulators:
   AuxiGro®:
      Active Ingredients: Gamma-aminobutyric acid (GABA) and glutamic acid
      Approved Crops: Fruits, vegetables, and grains.
6. Ethylene Pathway Modulators:
   Ethrel®:
      Active Ingredient: Ethephon
      Approved Crops: Wheat, coffee, tobacco, cotton, rice, and various fruits to promote ripening and facilitate harvesting.
   SmartFresh™
      Active Ingredient: 1-Methylcyclopropene (1-MCP)
      Approved Crops: Apples, pears, bananas, kiwifruit, persimmons, tomatoes, cantaloupes, and avocados.
   Others: aminoethoxyvinylglycine (AVG) and aminooxyacetic acid (AOA)
7. Jasmonic Acid Pathway Modulators:
   Methyl Jasmonate:
      Active Ingredient: Methyl jasmonate
      Approved Crops: Used on various crops to induce defense responses, enhancing resistance to pests and diseases.
8. Salicylic Acid Pathway Modulators:
   Bion® 50WG:
      Active Ingredient: Acibenzolar-S-methyl
      Approved Crops: Various crops to activate systemic acquired resistance against pathogens.
9. Brassinosteroid Pathway Modulators:
   Brassinolide:
      Active Ingredient: Brassinolide
      Approved Crops: Applied to various crops to promote growth and enhance stress tolerance.
10. Strigolactone Pathway Modulators:
   Tideglusib:
      Active Ingredient: Strigolactone analog
      Approved Crops: Used in research settings to study branching and stress responses in plants.

Below are major pathways and their applications for small molecule interventions:
1. Abscisic Acid (ABA) Signaling Pathway
   ABA is central to drought and salinity stress tolerance, regulating stomatal closure, gene expression, and osmotic stress responses.
   Small Molecules:
      ABA agonists: Compounds such as pyrabactin mimic ABA by binding to ABA receptors (PYR/PYL/RCAR) to activate downstream responses.
      ABA mimics: Small molecules that stabilize ABA receptor interactions, such as quinabactin.
      Inhibitors of ABA catabolism: Target enzymes like ABA 8\u2032-hydroxylase to maintain higher endogenous ABA levels.
   Applications: Enhancing drought and salinity tolerance through improved water-use efficiency and stomatal regulation.
2. Jasmonic Acid (JA) Signaling Pathway
   JA regulates responses to herbivory, wounding, and necrotrophic pathogens.
   Small Molecules:
      COR-like molecules: Coronatine (COR) mimics JA-Ile (bioactive form of JA) and activates JA signaling.
      Synthetic JA analogs: Molecules that induce expression of defense-related genes without the adverse effects of natural JA accumulation (e.g., growth inhibition).
      JAZ repressors disruptors: Compounds that degrade JAZ proteins (negative regulators of JA signaling), such as OPDA analogs.
   Applications: Enhancing resistance to herbivory and necrotrophic pathogens.
3. Salicylic Acid (SA) Signaling Pathway
   SA is essential for systemic acquired resistance (SAR) against biotrophic pathogens.
   Small Molecules:
      Benzothiadiazole (BTH): A functional analog of SA that primes plants for enhanced resistance.
      Isoflavonoids: Natural and synthetic compounds that activate the SA pathway without toxic effects.
      Plant activators: Compounds like acibenzolar-S-methyl (ASM) mimic SA to induce pathogenesis-related (PR) gene expression.
   Applications: Enhancing resistance to biotrophic pathogens and activating long-lasting defense responses.
4. Reactive Oxygen Species (ROS) Signaling Pathway
   ROS are critical secondary messengers in abiotic and biotic stress responses, but their levels must be tightly regulated.
   Small Molecules:
      ROS scavengers: Compounds like ascorbate and glutathione derivatives mitigate oxidative damage.
      ROS modulators: Molecules like diphenyleneiodonium (DPI) that regulate ROS production by targeting NADPH oxidases.
   Applications: Improving tolerance to oxidative stress caused by drought, salinity, or pathogens.
5. Calcium (Ca²⁺) Signaling Pathway
   Calcium ions are universal messengers in stress signaling, activating calcium-binding proteins like calmodulin and CDPKs (Calcium-Dependent Protein Kinases).
   Small Molecules:
      Ca²⁺ channel agonists: Compounds that modulate calcium influx to enhance downstream signaling.
      CDPK activators: Small molecules that specifically activate calcium-dependent protein kinases.
   Applications: Enhancing broad stress tolerance, including drought, salinity, and cold stress.
6. Strigolactone Signaling Pathway
   Strigolactones regulate plant architecture and mediate interactions with parasitic weeds and symbiotic fungi.
   Small Molecules:
      Strigolactone analogs: Synthetic strigolactones (e.g., GR24) promote beneficial mycorrhizal associations while inhibiting parasitic weed germination.
   Applications: Managing parasitic weed infestations (e.g., Striga spp.) and improving nutrient acquisition via mycorrhizal fungi.
7. Pattern-Triggered Immunity (PTI)
   PTI is a crucial first line of defense against pathogens and involves the recognition of conserved microbial patterns.
   Small Molecules:
      PAMP mimics: Synthetic peptides or compounds mimicking pathogen-associated molecular patterns (e.g., flg22) to prime PTI responses.
      PRR agonists: Molecules that enhance the activity of pattern recognition receptors (e.g., FLS2).
   Applications: Enhancing pathogen recognition and early defense activation.
8. Effector-Triggered Immunity (ETI)
   ETI is activated by specific pathogen effectors and resistance (R) proteins.
   Small Molecules:
      Compounds that mimic effector-triggered R protein activation.
      Defense priming molecules that strengthen ETI responses.
   Applications: Improving resistance against highly specialized pathogens.
9. Light Signaling Pathway
   Light signaling pathways regulate stress responses, including photoreceptor-mediated tolerance to oxidative stress.
   Small Molecules:
      Phytochrome modulators: Compounds that modulate phytochrome activity to enhance stress resistance.
      Flavonoids: Molecules that protect against UV-induced oxidative damage.
   Applications: Enhancing resilience to light-induced stress, such as UV radiation.
10. Heat Shock Protein (HSP) Pathway
   HSPs act as molecular chaperones, protecting cells from protein misfolding during heat stress.
   Small Molecules:
      HSP inducers: Compounds that enhance HSP expression, such as geldanamycin analogs.
   Applications: Improving thermotolerance in crops.

### Methods of Application

As used herein, “applying” a composition or product to a site refers to contacting a composition or product with a site such that the composition or product can have an effect on that site. The mode of application depends upon the formulation of the composition, and can include, for example, spraying, pouring, sprinkling, injecting, spreading, mixing, dunking, fogging, dripping, and misting. Formulations can include, for example, liquids, dry and/or wettable powders, soluble powders, flowable powders, dry flowables, emulsifiable concentrates, ultra-low-volume concentrates, dusts, granules (e.g., water dispersible granules), pellets, emulsions, microcapsules, nanocapsules, gels, pastes and/or aerosols. In an exemplary embodiment, the composition is applied after the composition has been prepared by, for example, mixing the composition with water.

In one embodiment, the site to which the composition is applied is the soil in which plants will be planted or are growing (e.g., a crop, a field, an orchard, a grove, a pasture/prairie or a forest). The compositions of the subject invention can be pre-mixed with irrigation fluids, wherein the compositions percolate through the soil and can be delivered to, for example, the soil. Alternatively, the compositions can be applied aerially. In one embodiment, the compositions are applied to soil surfaces, with or without water, where the beneficial effect of the soil application can be activated by rainfall, sprinkler, flood, or drip irrigation. The subject composition can be contacted to any plant tissue, such as, for example, the primary root, secondary root, stems, leaves, fruits, flowers, or seeds. In certain embodiments, the subject composition can be contacted to a target fungus tissue, such as, for example, the cap, gills, stem, or any combination thereof.

In certain embodiments, the crops can be treated in situ. In other embodiments, the crops can be relocated to a lab, or other site, in order to be treated with the compounds. In some embodiments, the plants being treated can be crops, which are grown and harvested for profit or subsistence. In other embodiments, the subject invention can be applied to foliage plants, angiosperms (flowering plants), mosses, liverworts, gymnosperms (conifers), ferns, monocots, dicots, perennial plants, or annual plants. In one embodiment, the composition is applied to a tract of land, such as farmland, pastureland, rangeland, forest land, or tracts cleared by natural fire and prescribed burns. In some embodiments, the plants being treated can be cereals (e.g., maize, rice, wheat, barley, sorghum, millet, oat, rye, triticale). In some embodiments, the plants being treated can be pseudocereals that are commonly called cereals, but do not botanically belong to the Poaceae family. In some embodiments, the pseudocereals that are treated can be buckwheat, quinoa, amaranth, or any combination thereof.

The methods and compositions of the subject invention can be used either alone or in combination with additional components, such as herbicides, fertilizers, pesticides and/or other soil amendments. Preferably, the additional components are non-toxic and environmentally-friendly. The exact materials and the quantities thereof can be determined by, for example, a grower or soil scientist having the benefit of the subject disclosure.

The methods of the subject invention can utilize standard methods and equipment that are used for maintenance of farmland or other soil. For example, the soil treatment composition can be applied in liquid form using an irrigation system. The composition can also be applied as a granule, as a coating (e.g., seed coating), or impregnated into prills. Additionally, the composition can be applied using a manual spreader, such as a broadcast spreader, a drop spreader, a handheld spreader, or a handheld sprayer. The composition can also be applied using aerial spreading (e.g., crop dusting), by, for example, airplane, helicopter, or drone.

Plants can be exposed to the subject compounds that can be formulated as pellets, capsules, sprays, mixed in water from the irrigation, added to waxes, paints or released from tanks, canisters, and even mounted on unmanned autonomous vehicles that are ariel or on the ground.

The compounds may be delivered with water or as a neat liquid, solid or solution. The compounds may be sprayed into soil at the time of planting, sprayed into soil at intervals post emergence, or sprayed on the foliage of a plant. In addition, the compounds may be applied to seeds prior to planting using established methods. For example, they may be coated on seeds with an inert vehicle, tumbled, and dried.

The compounds can be applied to soil or plants at any acceptable rate. For example, the compounds can be applied at a rate of at least about 1 kg per acre, at least about 2 kg per acre, at least about 5 kg per acre, at least about 10 kg per acre, or at least about 20 kg per acre, although higher application rates are not excluded.

In certain embodiments, the subject compositions can be stored at about 1° C. to about 37° C. or about 5° C. to about 25° C. In preferred embodiments, the plants or fungi are treated and grown at a temperature between about 5° C. to about 25° C. In other embodiments, the plants or fungi can be grown and treated at a temperature of about-10° C. to about 45° C.

### Auxiliary Technologies

The methods and compositions of the subject invention may be applied in combination with, or by utilizing, additional agricultural technologies, such as precision agriculture, remote and proximate imaging and image recognition, and agricultural site management programs. These technologies typically include models, e.g., computer programs, that support the user by considering information from a wide variety of sources to increase the quality and yield of harvested material, reduce damage by pests including the prediction of pest pressure and smart application of crop protection products, identify weed escapes to allow GPS guided spraying to control them, secure environmental protection, support quick and reliable agronomic decision making, reduce usage of fertilizers and crop protection products, reduce product residues in consumables increase spatial and temporal precision of agronomical measures, automate processes, and enable traceability of measures.

Information input for these models can include, but is not limited to, soil data (e.g., pH, organic matter content, moisture level, nutrient content such as nitrogen, potassium, phosphorous and micro-nutrient content); information on the plants that are currently growing or that may grow at the area of interest including crop plants and/or weeds (e.g. type of plant, chlorophyl levels, biomass, growth stage, plant health, plant water status, plant growth models, genetic traits, biotic damage by infestation or infection with pests, abiotic damage as caused by drought or nutrient stress etc.); weather information (e.g., information on past and present, and forecast of future temperature, humidity, and/or precipitation); information on the location of the area and directly derivable information thereof (e.g., terrain features like altitude, slope, water bodies, sun exposure and hours of sunshine per day, vegetation period, etc.); information on pest pressure (e.g., information of the past or present occurrence of unwanted vegetation, fungal diseases and invertebrate pests at the area of interest, at neighboring areas, the region, or the vegetation zone); information on beneficial organisms (e.g., information of the past or present occurrence of beneficial organisms at the area of interest, at neighboring areas, the region, or the vegetation zone); and/or historic information of any of the aforementioned (e.g., information on previous seasons, or of an earlier point in time of the same season).

Data sources typically include proximate-detection systems such as soil-borne sensors and remote sensing as may be achieved by imaging with, for example, unmanned airborne vehicles such as drones, or satellites. Imaging technologies include poly- and multispectral imagery in the UV-VIS, NIR and UV spectrums. Sensors may be directly or indirectly connected to a processing unit, e.g., via a wireless network and/or cloud applications. The information is typically taken into account by at least one processing unit and used to provide recommendations, generate control signals (e.g., for the control of agricultural machinery such as tractors, drones, irrigation systems, farm management systems and the like), and/or generate maps on the area of interest. These maps contain spatially and, optionally, temporally resolved information of the agricultural site, wherein the information may contain information directly gathered as described above, combinations thereof or derived therefrom, such as pest pressure, weed escapes, nutrient levels, and the like. The recommendations, control signals and maps may relate to, or be used for, controlling the application of water, nutrients, agrochemical products, or plant propagation material to the field of interest, or for taking other management measures such as tilling, physical, spot spraying or laser-induced weeding.

Technologies that can be used include self-steering machinery (such as tractors, harvesters, drones), artificial intelligence (e.g., machine learning), imaging technologies (e.g., image segmentation technologies), big data analysis, model generation, cloud computing, and machine-to-machine communication.

In preferred embodiments, the farming system utilizes spatially and/or temporally resolved, targeted application of active ingredients such as pesticides, plant-growth-regulators, fertilizers, and/or water including the variation of application rates over the agronomic site, zone or spot application, and of the spatially and/or temporally resolved, targeted planting or seeding of desired plant material to an agronomic site.

Geo-positioning technologies such as GPS can be used to gain information on the location and boundaries of an area of interest, the application equipment, sensing equipment and recorded data, and to control the actions of farm vehicles such as those used for spraying. By combining geo-positioning data with digital maps, it is possible to automate agricultural measures at the site of interest, e.g., by using autonomous spraying equipment.

Additional features can include the application of smart spraying equipment, e.g., spot spraying, and precision spraying at a farm, e.g., by irrigation systems, tractors, robots, helicopters, airplanes, and unmanned aerial vehicles, such as drones. Such equipment usually includes input sensors (such as a camera) and a processing unit configured to analyze the input data and to provide a recommendation or decision based on the analysis of the input data to apply the compositions of the invention to the site.

For example, weeds may be detected, identified, and/or classified from imagery acquired by a camera. Such identification and/classification can make use of image processing algorithms, which can utilize artificial intelligence (e.g., machine learning algorithms), or decision trees. In this manner, the methods and compositions described herein can be applied only at the required location, point in time and dose rate.

### Compositions

The subject invention provides, in preferred embodiments, such as PGR compositions comprising an active agriculture compound, such as a PGR, and an adjuvant of the subject invention. Typically, the composition further comprises at least one liquid and/or solid carrier and/or one or more surfactants and, if desired, one or more further auxiliaries, such as safeners, customary for agrochemical compositions.

In some embodiments, the concentration at which the adjuvant composition is employed imparts no or minimal PGR activity itself, while in other embodiments, the adjuvant composition is employed at a concentration such that the adjuvant composition has some level of activity, but that level is less than what is achieved when used in combination with the PGR. The adjuvant alone may have, for example, a level of activity that does not achieve commercial activity.

The adjuvant composition, agricultural chemical, and/or an agricultural composition formed by the two of these combined, can be formulated as suspension concentrates, aqueous suspensions, suspo-emulsions or capsule suspensions, emulsion concentrates, water dispersible granules, oil dispersions, emulsifiable concentrates, dispersible concentrates, wettable granules, wherein in the case of non-aqueous formulations or solid formulations a sprayable formulation can be obtained by adding a liquid carrier such as water.

In certain embodiments, the agricultural composition can comprise additional substances, such as, for example, water, carriers, pH adjusters, microbial inoculants, mineral sources, plant seeds, dyes, stabilizers, emulsifiers, prebiotics, polymers, buffering agents, viscosity modifiers, preservatives, nutrients for plant and/or beneficial microbe growth, tracking agents, biocides, surfactants, lubricants, solubility controlling agents, preservatives, and ultra-violet light resistant agents.

The pH of the composition should be suitable for the components of interest as well as for the plant and/or soil environment to which it will be applied. In some embodiments, the pH is about 2.0 to about 10.0, about 2.0 to about 9.5, about 2.0 to about 9.0, about 2.0 to about 8.5, about 2.0 to about 8.0, about 2.0 to about 7.5, about 2.0 to about 7.0, about 3.0 to about 7.5, about 4.0 to about 7.5, about 5.0 to about 7.5, about 5.5 to about 7.0, about 6.5 to about 7.5, about 3.0 to about 5.5, about 3.25 to about 4.0, or about 3.5. In certain embodiments, the pH is less than 6.0, e.g., about 2.0 to about 5.5. In certain other embodiments, the pH is greater than 6.0, e.g., about 8.5 to 12.0. Buffers, and pH regulators, such as carbonates and phosphates, may be used to stabilize pH near a preferred value.

In certain embodiments, carriers used according to the subject invention are those which can customarily be used for this purpose in agrochemical formulations. A carrier is a solid or liquid, natural or synthetic, organic or inorganic substance that is generally inert, and which may be used as a solvent. The carrier generally improves the application of the compounds, for instance, to plants, plants parts or seeds. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include, but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks. Preferred solid carriers are selected from clays, talc and silica.

Examples of suitable liquid carriers include, but are not limited to, water, organic solvents and combinations thereof. Examples of suitable solvents include polar and nonpolar organic chemical liquids, for example from the classes of alcohols and polyols (which may optionally also be substituted, etherified and/or esterified, such as ethanol, propanol, butanol, benzylalcohol, cyclohexanol or glycol, 2-ethyl hexanol), ethers such as dioctyl ether, tetrahydrofuran, dimethyl isosorbide, solketal, cyclopentyl methyl ether, solvents offered by Dow under the Dowanol Product Range e.g., Dowanol DPM, anisole, phenetole, different molecular weight grades of dimethyl polyethylene glycol, different molecular weight grades of dimethyl polypropylene glycol, dibenzyl ether ketones (such as acetone, methyl ethyl ketone, methyl isobutyl ketone, cyclopentanone, cyclohexanone, cycloheptanone, acetophenone, propiophenone), lactate esters, such as methyl lactate, ethyl lactate, propyl lactate, butyl lactate, 2-ethyl hexyl lactate (poly) ethers such as different molecular weight grades of polyethylene glycol, different molecular weight grades of polypropylene glycol unsubstituted and substituted amines amides (such as dimethylformamide, or N,N-dimethyl lactamide, or N-formyl morpholine, or fatty acid amides such N,N-dimethyl decanamide or N,N-dimethyl dec-9-en-amide) and esters thereof lactams (such as 2-pyrrolidone, or N-alkylpyrrolidones, such as N-methylpyrrolidone, or N-butylpyrrolidone, or N-octylpyrrolidone, or N-dodecylpyrrolidone or N-methyl caprolactam, N-alkyl caprolactam) lactones (such as gamma-butyrolactone, gamma-valerolactone, delta-valerolactone, or alphamethyl gamma-butyrolactone sulfones and sulfoxides (such as dimethyl sulfoxide), nitriles, such as linear or cyclic alkyl nitriles, in particular acetonitrile, cyclohexane carbonitrile, octanonitrile, dodecanonitrile). linear and cyclic carbonates, such as diethyl carbonate, dipropyl carbonate, dibutyl carbonate, dioctyl carbonate, or ethylene carbonate, propylene carbonate, butylene carbonate, glycerine carbonate. In preferred embodiments, the carrier is water, including any available source of water, such as rivers, lakes, and groundwater, and can include, for example, any potable water, some non-potable waters, and recycled water, such as the water from run-off.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Safeners are chemical compounds that prevent or reduce damage on useful plants without having a substantial impact on the herbicidal action of the herbicidal active components of the compositions towards unwanted plants. Safeners can be applied either before sowings (e.g., on seeds, shoots or seedlings) or in the pre-emergence application or post-emergence application of the crop.

The safeners and the herbicidal compositions can be applied jointly or separately.

Examples of safeners include benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, oxabetrinil, 4-(dichloroacetyl)-1-oxa-4-azaspiro[4.5]decane (MON4660, CAS 7152607-3), 2,2,5-trimethyl-3-(dichloroacetyl)-1,3-oxazolidine (R-29148, CAS 52836-31-4), metcamifen and BPCMS (CAS 54091 Jun. 4).

In the agrochemical compositions of the subject invention, the active ingredients and optional further ingredients are present in suspended, emulsified or dissolved form. The agrochemical compositions can be in the form of aqueous solutions, powders, suspensions, also highly-concentrated aqueous, oily or other suspensions or dispersions, aqueous emulsions, aqueous microemulsions, aqueous suspo-emulsions, oil dispersions, pastes, dusts, materials for spreading or granules.

The agrochemical compositions can be prepared in a known manner.

Suitable solvents and liquid carriers are water and organic solvents, such as mineral oil fractions of medium to high boiling point, e.g., kerosene, diesel oil; oils of vegetable or animal origin; aliphatic, cyclic and aromatic hydrocarbons, e.g., toluene, paraffin, tetrahydronaphthalene, alkylated naphthalenes; alcohols, e.g., ethanol, propanol, butanol, benzylalcohol, cyclohexanol; glycols; DMSO; ketones, e.g., cyclohexanone; esters, e.g., lactates, carbonates, fatty acid esters, gamma-butyrolactone; fatty acids; phosphonates; amines; amides, e.g., N-methylpyrrolidone, fatty acid dimethylamides; and mixtures thereof.

Suitable solid carriers or fillers are mineral earths, e.g., silicates, silica gels, talc, kaolins, limestone, lime, chalk, clays, dolomite, diatomaceous earth, bentonite, calcium sulfate, magnesium sulfate, magnesium oxide; polysaccharides, e.g., cellulose, starch; fertilizers, e.g., ammonium sulfate, ammonium phosphate, ammonium nitrate, ureas; products of vegetable origin, e.g., cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in Mccutcheon's, Vol. 1: Emulsifiers & Detergents, Mccutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable thickeners are polysaccharides (e.g., xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g., in red, blue, or green) are pigments of low water solubility and water-soluble dyes. Examples are inorganic colorants (e.g., iron oxide, titan oxide, iron hexacyanoferrate) and organic colorants (e.g., alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Examples for agrochemical composition types and their preparation are:

### i) Water-Soluble Concentrates (SL, LS)

10-60 wt % of a composition according to the invention and 5-15 wt % wetting agent (e.g. alcohol alkoxylates) are dissolved in water and/or in a water-soluble solvent (e.g., alcohols) ad 100 wt %. The active substance dissolves upon dilution with water.

### ii) Dispersible Concentrates (DC)

5-25 wt % of a composition according to the invention and 1-10 wt % dispersant (e.g., polyvinylpyrrolidone) are dissolved in organic solvent (e.g., cyclohexanone) ad 100 wt %. Dilution with water gives a dispersion.

iii) Emulsifiable Concentrates (EC)

15-70 wt % of a composition according to the invention and 5-10 wt % emulsifiers (e.g., calcium dodecylbenzenesulfonate and castor oil ethoxylate) are dissolved in water-insoluble organic solvent (e.g., aromatic hydrocarbon) ad 100 wt %. Dilution with water gives an emulsion.

### iv) Emulsions (EW, EO, ES)

5-40 wt % of a composition according to the invention and 1-10 wt % emulsifiers (e.g., calcium dodecylbenzenesulfonate and castor oil ethoxylate) are dissolved in 20-40 wt % water-insoluble organic solvent (e.g., aromatic hydrocarbon). This mixture is introduced into water ad 100 wt % by means of an emulsifying machine and made into a homogeneous emulsion. Dilution with water gives an emulsion.

### v) Suspensions (SC, OD, FS)

In an agitated ball mill, 20-60 wt % of a composition according to the invention are comminuted with addition of 2-10 wt % dispersants and wetting agents (e.g., sodium lignosulfonate and alcohol ethoxylate), 0, 1-2 wt % thickener (e.g., xanthan gum) and water ad 100 wt % to give a fine active substance suspension. Dilution with water gives a stable suspension of the active substance. For FS type composition up to 40 wt % binder (e.g., polyvinylalcohol) is added.

### vi) Water-Dispersible Granules and Water-Soluble Granules (WG, SG)

50-80 wt % of a composition according to the invention are ground finely with addition of dispersants and wetting agents (e.g., sodium lignosulfonate and alcohol ethoxylate) ad 100 wt % and prepared as water-dispersible or water-soluble granules by means of technical appliances (e.g., extrusion, spray tower, fluidized bed). Dilution with water gives a stable dispersion or solution of the active substance.

vii) Water-Dispersible Powders and Water-Soluble Powders (WP, SP, WS)

50-80 wt % of a composition according to the invention are ground in a rotor-stator mill with addition of 1-5 wt % dispersants (e.g., sodium lignosulfonate), 1-3 wt % wetting agents (e.g., alcohol ethoxylate) and solid carrier (e.g., silica gel) ad 100 wt %. Dilution with water gives a stable dispersion or solution of the active substance.

viii) Gel (GW, GF)

In an agitated ball mill, 5-25 wt % of a composition according to the invention are comminuted with addition of 3-10 wt % dispersants (e.g., sodium lignosulfonate), 1-5 wt % thickener (e.g., carboxymethylcellulose) and water ad 100 wt % to give a fine suspension of the active substance. Dilution with water gives a stable suspension of the active substance.

### ix) Microemulsion (ME)

5-20 wt % of a composition according to the invention are added to 5-30 wt % organic solvent blend (e.g., fatty acid dimethylamide and cyclohexanone), 10-25 wt % surfactant blend (e.g., alcohol ethoxylate and arylphenol ethoxylate), and water ad 100%. This mixture is stirred for 1 h to produce spontaneously a thermodynamically stable microemulsion.

### x) Microcapsules (CS)

An oil phase comprising 5-50 wt % of a composition according to the invention, 0-40 wt % water insoluble organic solvent (e.g., aromatic hydrocarbon), 2-15 wt % acrylic monomers (e.g., methylmethacrylate, methacrylic acid and a di- or triacrylate) are dispersed into an aqueous solution of a protective colloid (e.g., polyvinyl alcohol). Radical polymerization initiated by a radical initiator results in the formation of poly(meth)acrylate microcapsules. Alternatively, an oil phase comprising 5-50 wt % of a compound I according to the invention, 0-40 wt % water insoluble organic solvent (e.g. aromatic hydrocarbon), and an isocyanate monomer (e.g., diphenylmethene-4,4′-diisocyanate) are dispersed into an aqueous solution of a protective colloid (e.g., polyvinyl alcohol). The addition of a polyamine (e.g., hexamethylenediamine) results in the formation of polyurea microcapsules. The monomers amount to 1-10 wt %. The wt % relate to the total CS composition.

### xi) Dustable Powders (DP, DS)

1-10 wt % of a composition according to the invention are ground finely and mixed intimately with solid carrier (e.g., finely divided kaolin) ad 100 wt %.

xii) Granules (GR, FG)

0.5-30 wt % of a composition according to the invention is ground finely and associated with solid carrier (e.g., silicate) ad 100 wt %. Granulation is achieved by extrusion, spray-drying or the fluidized bed.

xiii) Ultra-Low Volume Liquids (UL)

1-50 wt % of a composition according to the invention are dissolved in organic solvent (e.g. aromatic hydrocarbon) ad 100 wt %.

The agrochemical compositions types i) to xiii) may optionally comprise further auxiliaries, such as 0.1-1 wt % bactericides, 5-15 wt % anti-freezing agents, 0.1-1 wt % anti-foaming agents, and 0.1-1 wt % colorants.

The agrochemical compositions generally comprise between 0.01 and 95%, preferably between 0.1 and 90%, and in particular between 0.5 and 75%, by weight of active substance. The active substances are employed in a purity of from 90% to 100%, preferably from 95% to 100% (according to NMR spectrum).

Solutions for seed treatment (LS), suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions give, after two-to-tenfold dilution, active substance concentrations of from 0.01 to 60% by weight, preferably from 0.1 to 40% by weight, in the ready-to-use preparations. Application can be carried out before or during sowing.

Methods for applying compositions of the invention on to plant propagation material, especially seeds include dressing, coating, pelleting, dusting, soaking and in-furrow application methods of the propagation material.

Various types of oils, wetters, adjuvants, fertilizer or micronutrients, pesticides (e.g., herbicides, insecticides, fungicides, growth regulators) or safeners as mentioned above may be added to the compositions.

These agents can be admixed with the compositions according to the invention in a weight ratio of 1:100 to 100:1, preferably 1:10 to 10:1.

The invention also relates to compositions in the form of an agrochemical composition formulated as a 2-component composition comprising a first component comprising a PGR, a solid or liquid carrier and/or one or more surfactants, and a second component comprising an adjuvant of the subject invention, a solid or liquid carrier and/or one or more surfactants, where additionally both components may also comprise further auxiliaries customary for agrochemical compositions.

All plants and plant parts can be treated in accordance with the invention. Plant parts or tissues are understood as meaning all aerial and subterranean parts and organs of the plants, such as a shoot, leaf, flower and root, examples which may be mentioned being leaves, needles, stalks, stems, flowers, buds, fruit bodies, fruits and seeds, but also roots, tubers and rhizomes. The plant parts also include crop material and vegetative and generative propagation material, for example cuttings, tubers, rhizomes, slips and seeds.

We claim:

1. A composition comprising an adjuvant compound from Table 1, Table 2 or Table 3, and a plant growth regulator (PGR) compound.

2. The composition according to claim 1, wherein the PGR is selected from Gibberellin Pathway Modulators; Abscisic Acid (ABA) Pathway Modulators; Cytokinin Pathway Modulators; Systemic Acquired Resistance (SAR) Inducers; Auxin Pathway Modulators; Ethylene pathway Modulators; Jasmonic Acid Pathway Modulators; Salicylic Acid Pathway Modulators; Brassinosteroid Pathway Modulators; and Strigolactone Pathway Modulators.

3. The composition according to claim 1, wherein the PGR compound is present at a concentration that is equal to or less than the concentration of the PGR needed to achieve the PGR activity in the absence of the adjuvant compound.

4. The composition according to claim 1, wherein the PGR compound is selected from Gibberellic Acid (GA3); S-Abscisic Acid (S-ABA); Forchlorfenuron; Acibenzolar-S-methyl; Gamma-aminobutyric acid (GABA); glutamic acid; Ethephon; 1-Methylcyclopropene; Aminoethoxyvinylglycine; Aminooxyacetic acid; Methyl jasmonate; Acibenzolar-S-methyl; Brassinolide; and Strigolactone analogs.

5. The composition according to claim 1, wherein the adjuvant compound is selected from benzyl salicylate, isoamyl salicylate, butyl salicylate, Benzyl Benzoate, phenethyl butyrate, iso-amyl butyrate, Geranyl Formate, Citronellyl Formate, and gamma-Cyclodextrin.

6. The composition according to claim 1, further comprising one or more additional substances selected from water, carriers, pH adjusters, microbial inoculants, mineral sources, plant seeds, dyes, stabilizers, emulsifiers, prebiotics, polymers, buffering agents, viscosity modifiers, preservatives, nutrients for plant and/or beneficial microbe growth, tracking agents, biocides, surfactants, lubricants, solubility controlling agents, preservatives, and ultra-violet light resistant agents.

7. A method for modulating a plant metabolic pathway, wherein said method comprises applying to the plant a composition comprising an adjuvant compound from Table 1, Table 2 or Table 3, and a PGR compound,
wherein the adjuvant compound elicits no effect on the plant metabolic pathway when applied without the PGR compound, and
wherein combined application of the adjuvant compound and the PGR compound results in a greater modulation of the plant metabolic pathway relative to the PGR alone.

8. The method according to claim 7, wherein the PGR is selected from Gibberellin Pathway Modulators; Abscisic Acid (ABA) Pathway Modulators; Cytokinin Pathway Modulators; Systemic Acquired Resistance (SAR) Inducers; Auxin Pathway Modulators; Ethylene pathway Modulators; Jasmonic Acid Pathway Modulators; Salicylic Acid Pathway Modulators; Brassinosteroid Pathway Modulators; and Strigolactone Pathway Modulators.

9. The method according to claim 7, wherein the adjuvant compound is selected from Gibberellic Acid (GA3); S-Abscisic Acid (S-ABA); Forchlorfenuron; Acibenzolar-S-methyl; Gamma-aminobutyric acid (GABA); glutamic acid; Ethephon; 1-Methylcyclopropene; Aminoethoxyvinylglycine; Aminooxyacetic acid; Methyl jasmonate; Acibenzolar-S-methyl; Brassinolide; and Strigolactone analogs.

10. The method according to claim 7, wherein the adjuvant compound is selected from benzyl salicylate, isoamyl salicylate, butyl salicylate, Benzyl Benzoate, phenethyl butyrate, iso-amyl butyrate, Geranyl Formate, Citronellyl Formate, and gamma-Cyclodextrin.

11. The method according to claim 7, wherein the PGR compound is applied at a concentration that is equal to or less than the concentration of the PGR needed to achieve the PGR activity in the absence of the adjuvant compound.

12. The method according to claim 7, wherein the plant is in an agriculture field where corn, cotton, wheat, soybeans, grapes, coffee, cacao, tea, tree nuts, tree fruits, small fruits and vegetables are growing, or will be grown.

13. The method according to claim 7, further comprising testing the effects of the composition on modulating the plant metabolic pathway by quantifying a parameter in the plant before and after treatment, wherein the parameter is altered by the PGR, and wherein the parameter is selected from stress tolerance, resistance to pathogens, resistance to pests, ripening time, flowering time, shoot structure and growth, root structure and growth, water consumption, cold tolerance, heat tolerance, flooding tolerance, or production of metabolites.

14. A method for:
increasing or reducing a plant's tolerance to stress, resistance to pathogens, and/or resistance to pests;
altering a plant response to an environmental signal;
promoting or delaying a plant's ripening time and/or flowering time;
altering a plant's root and/or shoot structure and growth;
increasing or decreasing a plant's tolerance to heat or to cold temperatures; and/or
increasing or decreasing a plant's production of metabolites;
wherein said method comprises applying to the plant an adjuvant compound from Table 1, 2 or 3, and a PGR compound.

15. The method according to claim 14, used to increase or decrease a plant's tolerance to stress, resistance to pathogens, and/or resistance to pests.

16. The method according to claim 14, used to alter a plant response to an environmental signal.

17. The method according to claim 14, used to promote or delay a plant's ripening time and/or flowering time.

18. The method according to claim 14, used to alter a plant's root and/or shoot structure and growth.

19. The method according to claim 14, used to increase or decrease a plant's tolerance to heat or to cold temperatures.

20. The method according to claim 14, used to increase or decrease a plant's production of metabolites, wherein the metabolites are sugars, medicinal compounds, flavors, fragrances and/or dyes.
